(19) United States
(12) Patent Application Publication
(10) Pub. No.: US 2023/0146880 A1
(43) Pub. Date: May 11, 2023

(54) MANAGEMENT SYSTEM AND MANAGEMENT METHOD

(71) Applicant: RAKUTEN MOBILE, INC., Tokyo (JP)

(72) Inventor: Kazushige TAKEUCHI, Setagaya-ku, Tokyo (JP)

(21) Appl. No.: 17/906,743

(22) PCT Filed: Mar. 12, 2021
(86) PCT No.: PCT/JP2021/010206

§ 371 Date: Sep. 19, 2022

(51) Int. Cl. H04L 41/0893; H04L 61/4511

(52) U.S. Cl. CPC H04L 41/0893; H04L 61/4511

(57) ABSTRACT

Provided are a management system and a management method which are capable of smoothly extending a communication system. A GC cluster registers resource data indicating an address of an external system capable of responding to any computer system in response to reception of a communication establishment request from the computer system. A bfd unit establishes communication between a given computer system and the external system in response to registration of the resource data by performing control so that the given computer system transmits the communication establishment request to the external system having the address indicated in the resource data. The GC cluster sets a role, in a given process to be executed by the given computer system, of the external system with which the communication has been established.

### TECHNICAL FIELD

The present invention relates to a management system and a management method.

### BACKGROUND ART

In Patent Literature 1, there are described a configuration in which a domain name system (DNS) server executes alive monitoring and load information collection for other servers and a configuration in which, when a server in an active system is brought into a high load state or an out-of-service state, the DNS server issues an activation command to a server in a standby system, and distributes, to the standby system, an access from a client terminal that newly connects to the server.

### CITATION LIST

### Patent Literature

[Patent Literature 1] JP 2019-168920 A

### SUMMARY OF INVENTION

### Technical Problem

Currently, a cluster of nodes which execute applications virtualized in a container type (hereinafter also referred to as “containerized applications”) may be constructed for each site, for example, a datacenter so that one communication system is constructed as a whole.

In this communication system, a cluster responsible for a certain function may be additionally constructed. For example, in order to increase availability of the communication system, a new cluster for backing up an existing cluster responsible for a certain function may be additionally constructed.

However, when the cluster is to be additionally constructed, even when the above-mentioned technology described in Patent Literature 1 is applied, for example, it is required for a developer to manually change setting of the DNS server, which takes time, and thus the communication system cannot smoothly be extended.

This problem is applied not only to a communication system including a plurality of clusters, but is also applied similarly to a general communication system including a plurality of subsystems, which are not clusters.

The present invention has been made in view of the above-mentioned actual situation, and has an object to provide a management system and a management method which are capable of smoothly extending a communication system.

### Solution to Problem

In order to solve the above-mentioned problem, according to one embodiment of the present invention, there is provided a management system including: resource data registration means for registering resource data indicating an address of an external system capable of responding to any computer system in response to reception of a communication establishment request from the any computer system; communication establishment means for establishing communication between a given computer system and the external system in response to registration of the resource data by performing control so that the given computer system transmits the communication establishment request to the external system having the address indicated in the resource data; and role setting means for setting a role, in a given process to be executed by the given computer system, of the external system with which the communication has been established.

In one aspect of the present invention, the resource data registration means is configured to register the resource data indicating an address of a new external system when the given computer system is executing the given process in cooperation with an existing external system, the communication establishment means is configured to establish communication between the given computer system and the new external system in response to the registration of the resource data, and the role setting means is configured to set a role, in the given process, of the new external system with which the communication has been established, in terms of a relationship with the existing external system.

In this aspect, the role setting means may be configured to set the role of the new external system as a backup of the existing external system.

Further, the management system may further include transmission means for transmitting, to the existing external system, target data relating to the given process, and the transmission means may be configured to transmit the target data to the new external system in place of the existing external system when a failure of the existing external system occurs or a failure of a communication path between the given computer system and the existing external system occurs.

Further, the management system may further include reception means for receiving a packet which is repeatedly transmitted from the existing external system, and is used to monitor normality of a path to the existing external system, and the transmission means may be configured to transmit the target data to the new external system in place of the existing external system when the packet has not been received from the existing external system.

Further, the reception means may be configured to further receive a packet which is repeatedly transmitted from the new external system, and is used to monitor normality of a path to the new external system, and the transmission means may be configured to transmit the target data to the new external system in place of the existing external system when the packet has not been received from the existing external system, and the packet has been received from the new external system.

Further, the packet may be a bidirectional forwarding detection (BFD) packet.

Further, in one aspect of the present invention, the management system may further include service data registration means for registering service data indicating the role of the external system in the given process.

In this aspect, the service data may be a domain name system (DNS) record to be used for name resolution for a transmission destination of the target data relating to the given process.

According to one embodiment of the present invention, there is provided a management method including the steps of: registering resource data indicating an address of an external system capable of responding to any computer system in response to reception of a communication establishment request from the any computer system; establishing communication between a given computer system and the external system in response to registration of the resource data by performing control so that the given computer system transmits the communication establishment request to the external system having the address indicated in the resource data; and setting a role, in a given process to be executed by the given computer system, of the external system with which the communication has been established.

Any combination of the components described above, and modes in which the expressions in the present disclosure are adapted to, for example, a device, a computer program, or a recording medium in which a computer program is readably recorded, are also valid modes of the present disclosure.

### BRIEF DESCRIPTION OF DRAWINGS

FIG. 1 is a diagram for illustrating a configuration of computer systems in which clusters of nodes which execute containerized applications are constructed.

FIG. 2 is a diagram for illustrating a configuration of a communication system in a first embodiment of the present disclosure.

FIG. 3 is a diagram for illustrating an example of a DNS record stored in a coreDNS of a GC cluster.

FIG. 4 is a flowchart for illustrating an operation of the GC cluster.

FIG. 5 is a diagram for illustrating an example of the DNS record stored in the coreDNS of the GC cluster.

FIG. 6 is a diagram for illustrating a configuration of a communication system in a second embodiment of the present disclosure.

FIG. 7 is a diagram for illustrating an example of the DNS record stored in the coreDNS of the GC cluster.

FIG. 8 is a flowchart for illustrating an operation of the GC cluster.

FIG. 9 is a diagram for illustrating an example of data structure of service data.

FIG. 10 is a diagram for illustrating a configuration of a communication system in a third embodiment of the present disclosure under a state in which a CDC2 is not added.

FIG. 11 is a flowchart for illustrating an example of a flow of a process executed by the GC cluster.

### DESCRIPTION OF EMBODIMENTS

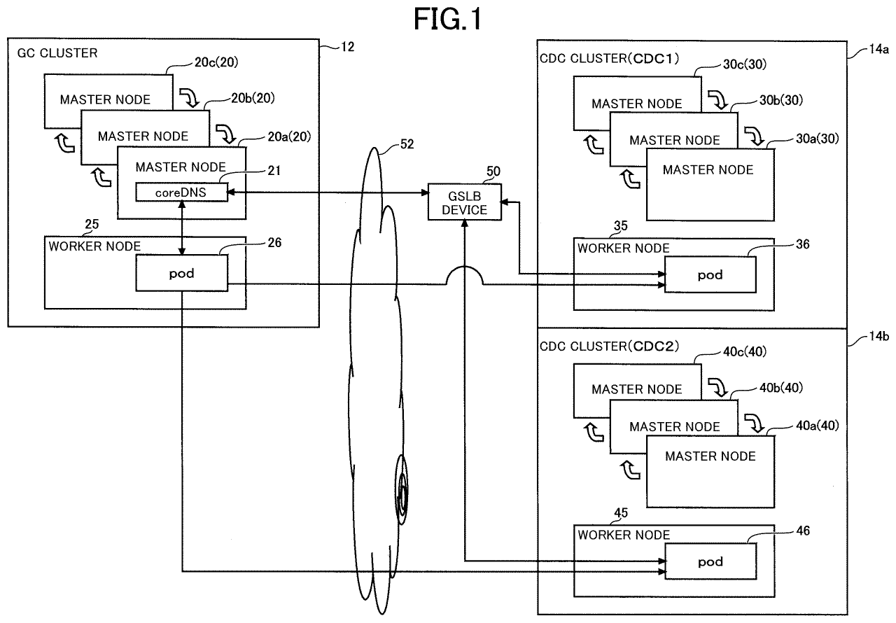

An overview of embodiments of the present disclosure is now described. FIG. 1 shows a configuration of computer systems in which clusters of nodes (also considered as computers and servers) which execute containerized applications are constructed. In FIG. 1, as the plurality of computer systems in which the clusters are constructed, a GC cluster 12, a CDC cluster 14a, and a CDC cluster 14b are illustrated.

The GC cluster 12 is a cluster constructed at a group unit center (GC) station of a mobile network operator. The cluster in the embodiments is a set of nodes in which software (specifically, Kubernetes) for managing containerized workloads and services is installed. Moreover, the clusters in the embodiments are Kubernetes clusters which define an extent in which the Kubernetes can manage pods, which are containerized applications. The Kubernetes cluster can also be considered as a set of a plurality of nodes to which the Kubernetes can deploy the pods.

The GC cluster 12 includes a plurality of master nodes 20 (a master node 20a, a master node 20b, and a master node 20c) and a plurality of worker nodes 25 (one node is illustrated in FIG. 1). To the worker node 25, a pod 26, which is an application which executes various types of data processes (business operation processes and the like), and is a containerized application, is deployed. The pod 26 can also be considered as a cloud-native network function (CNF) instance.

Each of the plurality of master nodes 20 is a node which manages a plurality of worker nodes 25 and a plurality of pods 26. Each of the plurality of master nodes 20 includes a coreDNS 21, which is a domain name system (DNS) server which provides a name resolution service to the pods 26 in the cluster. One leader is selected from the plurality of master nodes 20. In FIG. 1, the master node 20a is selected as the leader.

The CDC cluster 14a is a Kubernetes cluster constructed in a CDC1, which is a first central data center (CDC) of the mobile network operator. The CDC cluster 14a includes a plurality of master nodes 30 (a master node 30a, a master node 30b, and a master node 30c) and a plurality of worker nodes 35 (one node is illustrated in FIG. 1). To the worker node 35, a pod 36, which executes various types of data processes (business operation processes and the like), is deployed.

The CDC cluster 14b is a Kubernetes cluster constructed in a CDC2, which is a second CDC of the mobile network operator. The CDC cluster 14b includes a plurality of master nodes 40 (a master node 40a, a master node 40b, and a master node 40c) and a plurality of worker nodes 45 (one node is illustrated in FIG. 1). To the worker node 45, a pod 46, which executes various types of data processes (business operation processes and the like), is deployed.

In the embodiments, the pod 26 of the GC cluster 12 transmits, to the pod 36 of the CDC cluster 14a, data (hereinafter referred to as “target data”) relating to an application process. The target data includes, for example, process results of the pod 26 deployed into the GC cluster 12. When a failure occurs in the CDC cluster 14a, the pod 26 of the GC cluster 12 transmits the target data to the pod 46 of the CDC cluster 14b in place of the pod 36 of the CDC cluster 14a.

It has hitherto been required for communication between nodes of different Kubernetes clusters to make access to a GSLB device 50 (also referred to as “infrastructure DNS”) provided outside the clusters, to thereby execute name resolution for a pod (for example, pod 36) of a transmission destination. The GSLB device 50 periodically transmits predetermined data to the pod 36 of the CDC cluster 14a, to thereby periodically execute health check for the pod 36. Moreover, the GSLB device 50 periodically transmits predetermined data to the pod 46 of the CDC cluster 14b, to thereby periodically execute health check for the pod 46.

The pod 26 of the GC cluster 12 requests the coreDNS 21 for the name resolution for a name of a pod being a transmission destination (for example, a transmission destination virtual domain name of virtualized pod 36 and pod 46). The coreDNS 21 requests the GSLB device 50 for the name resolution for the transmission destination pod name. When the state of the pod 36 of the CDC cluster 14a is normal, the GSLB device 50 transmits, as a response to the name resolution request, an IP address of the pod 36 to the coreDNS 21 of the GC cluster 12. The coreDNS 21 returns the IP address of the pod 36 to the pod 26 in the own cluster. The pod 26 transmits, based on the IP address of the pod 36 provided by the coreDNS 21, the target data to the pod 36 of the CDC cluster 14a.

Meanwhile, when the state of the pod 36 of the CDC cluster 14a is abnormal, the GSLB device 50 detects the abnormal state. The GSLB device 50 transmits, as a response to the name resolution request, an IP address of the pod 46 of the CDC cluster 14b to the coreDNS 21 of the GC cluster 12. The coreDNS 21 returns the IP address of the pod 46 to the pod 26 in the own cluster. The pod 26 transmits, based on the IP address of the pod 46 provided by the coreDNS 21, the target data to the pod 46 of the CDC cluster 14b.

The GC cluster 12 and the GSLB device 50 are connected to each other via a WAN 52 including a layer 2 (L2) communication section (for example, Ethernet (trademark)). When a failure occurs in the L2 communication path under a normal state in the WAN 52, a relatively long period of time is required until the L2 communication path under the normal state is switched to an L2 communication path for backup. Thus, when a failure occurs in the WAN 52 between the GC cluster 12 and the GSLB device 50, time is required to obtain the IP address of the transmission destination pod from the GSLB device 50, and thus the communication between the GC cluster 12 and the CDC cluster 14a (or the CDC cluster 14b) may be delayed.

Thus, in a first embodiment and a second embodiment of the present disclosure, there is used, in communication between a plurality of Kubernetes clusters, a packet which is repeatedly transmitted every several seconds from a Kubernetes cluster of a transmission destination, and is used to monitor the normality of a path between a Kubernetes cluster of a transmission source and the Kubernetes cluster of the transmission destination, to thereby suppress a delay in communication between a plurality of Kubernetes clusters. The packet in the embodiments is a bidirectional forwarding detection (BFD) packet transmitted and received by a BFD function.

### First Embodiment

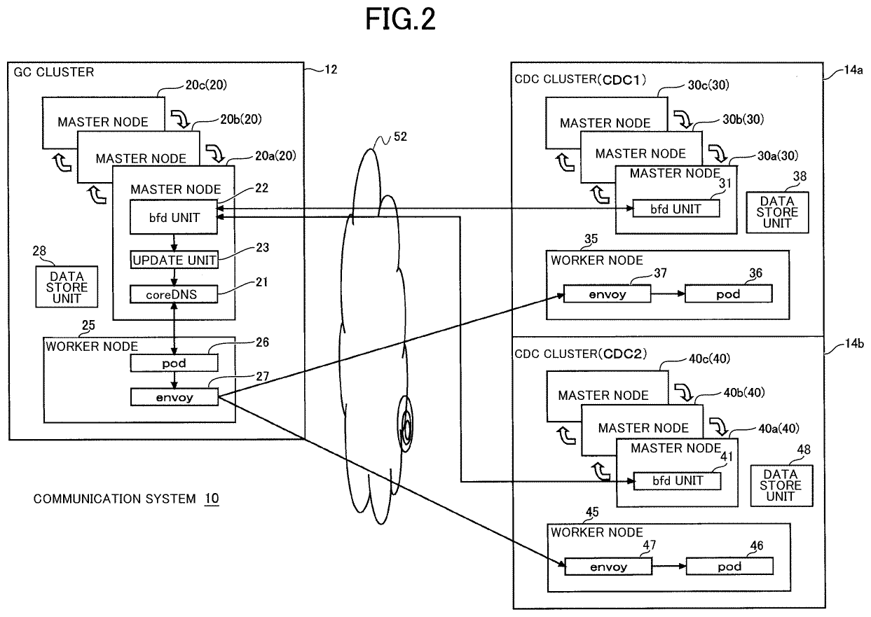

FIG. 2 shows a configuration of a communication system 10 in the first embodiment. FIG. 2 includes a block diagram for illustrating functional blocks included in each component of the communication system 10. Each block illustrated in the block diagram of the present disclosure can be implemented, in terms of hardware, by elements such as a CPU and a memory of a computer and mechanical devices, and can be implemented, in terms of software, by computer programs and the like, but functional blocks implemented by cooperation therebetween are illustrated here. A person skilled in the art would understand that those functional blocks can be implemented in various forms by combinations of hardware and software.

A node configuration of the GC cluster 12 of the communication system 10 is the same as the node configuration of the GC cluster 12 of FIG. 1 described above. The GC cluster 12 of the communication system 10 is a computer system in which the Kubernetes cluster being a cluster of nodes which executes the pods is constructed. Moreover, the GC cluster 12 is a computer system being a transmission source of transmission target data (hereinafter referred to as “target data”) relating to a process executed by the pods. The GC cluster 12 includes a communication unit which communicates to and from the plurality of external systems (the CDC cluster 14a and the CDC cluster 14b in the first embodiment) in the nodes (that is, in the nodes forming the cluster). The communication unit includes a bfd unit 22 provided in the master node 20 and an envoy 27 provided in the worker node 25. A detailed description is later given of the bfd unit 22 and the envoy 27.

The master node 20 includes the coreDNS 21, the bfd unit 22, and an update unit 23. The worker node 25 includes the pod 26 and the envoy 27. The envoy 27 can be considered as a proxy unit, defined by a publicly known service mesh, which performs, by proxy, hooking of transmission data output from among transmission source applications, and transmission of the transmission data to a transmission destination application in accordance with a predetermined communication protocol.

The GC cluster 12 is connected to the CDC cluster 14a and the CDC cluster 14b via the WAN 52 including the L2 communication section. A node configuration of the CDC cluster 14a of the communication system 10 is the same as the node configuration of the CDC cluster 14a of FIG. 1 described above. The CDC cluster 14a is a computer system in which the Kubernetes cluster is constructed, and is a first external computer system being the original transmission destination of the target data. The master node 30 includes a bfd unit 31. The worker node 35 includes the pod 36 and an envoy 37.

A node configuration of the CDC cluster 14b of the communication system 10 is the same as the node configuration of the CDC cluster 14b of FIG. 1 described above. As in the CDC cluster 14a, the CDC cluster 14b is also a computer system in which a Kubernetes cluster is constructed. The CDC cluster 14b is a second external computer system which serves, in place of the CDC cluster 14a, as the transmission destination of the target data when a failure occurs in the CDC cluster 14a or when a failure occurs in the communication path between the GC cluster 12 and the CDC cluster 14a. The master node 40 includes a bfd unit 41. The worker node 45 includes the pod 46 and an envoy 47.

The functions of one or more functional blocks on a certain node may be implemented in a computer-readable computer program. This computer program may be stored in a non-transitory recording medium, or may be installed in a storage of the node via this recording medium. As another example, the computer program may be downloaded via a network, and is installed in the storage of the node. The CPU of the node may read the computer program into a main memory to execute the computer program, to thereby provide the functions of the one or more functional blocks of the node.

As a reception unit included in the communication unit, the bfd unit 22 of the GC cluster 12 sequentially receives the BFD packet repeatedly transmitted every several seconds from the bfd unit 31 of the CDC cluster 14a. When, as the transmission unit included in the communication unit, the pod 26 and the envoy 27 of the GC cluster 12 have not received the BFD packet from the CDC cluster 14a, the pod 26 and the envoy 27 transmit the target data to the CDC cluster 14b in place of the CDC cluster 14a.

When a failure occurs in the CDC cluster 14a, or a failure occurs in the communication path between the GC cluster 12 and the CDC cluster 14a, the BFD packet from the CDC cluster 14a has not been received. In this case, the GC cluster 12 can quickly detect the failure to quickly switch the transmission destination of the target data to the CDC cluster 14b.

As the reception unit included in the communication unit, the bfd unit 22 of the GC cluster 12 further sequentially receives the BFD packet repeatedly transmitted every several seconds from the bfd unit 41 of the CDC cluster 14b. When, as the transmission unit included in the communication unit, the pod 26 and the envoy 27 of the GC cluster 12 have not received the BFD packet from the CDC cluster 14a while the pod 26 and the envoy 27 continue to receive the BFD packet from the CDC cluster 14b, the pod 26 and the envoy 27 transmit the target data to the CDC cluster 14b in place of the CDC cluster 14a.

According to this aspect, when a failure occurs in the CDC cluster 14a, or a failure occurs in the communication path between the GC cluster 12 and the CDC cluster 14a, the transmission destination of the target data is quickly switched to the CDC cluster 14b under a condition that the state of communication to/from the CDC cluster 14b is normal. As a result, the target data can more reliably be delivered to the transmission destination.

The coreDNS 21 of the GC cluster 12 executes, for the pod 26 included in the cluster, the name resolution for the transmission destination of the target data. As the transmission unit included in the communication unit, the pod 26 and the envoy 27 inquire of the coreDNS 21 a transmission destination address of the target data, and transmit the target data to the transmission destination address provided from the coreDNS 21. When the update unit 23 has not received the BFD packet from the CDC cluster 14a, the update unit 23 updates a record of the coreDNS 21 such that the transmission destination address of the target data is changed from the address of the CDC cluster 14a to the address of the CDC cluster 14b. According to this aspect, the transmission destination of the target data can flexibly be changed by updating the record of the coreDNS 21.

An operation of the communication system 10 in the first embodiment is now described.

First, with reference to FIG. 2, description is given of the operation at the time when the communication system 10 is constructed. The GC cluster 12 may include a data store unit 28. The data store unit 28 registers resources (for example, the master nodes 20, the coreDNSes 21, the bfd units 22, the update units 23, the worker nodes 25, the pods 26, and the envoys 27) of the Kubernetes cluster in response to an operation of a developer. In a data store unit 38 of the CDC cluster 14a and a data store unit 48 of the CDC cluster 14b, the resources of the Kubernetes clusters are also similarly registered. The data store units 28, 38, and 48 can be implemented by, for example, a kube-apiserver, an etcd, and the like of the Kubernetes.

The bfd unit 22 of the GC cluster 12 executes negotiation with the bfd unit 31 of the CDC cluster 14a in response to an operation of the developer. Moreover, the bfd unit 22 of the GC cluster 12 executes negotiation with the bfd unit 41 of the CDC cluster 14b in response to an operation of the developer. A transmission destination and a transmission timing of the BFD packet are set through this negotiation. Each of the GC cluster 12, the CDC cluster 14a, and the CDC cluster 14b executes a leader selection process for the master nodes 20, 30 and 40. In the embodiment, it is assumed that the master node 20a, the master node 30a, and the master node 40a are selected as the leaders.

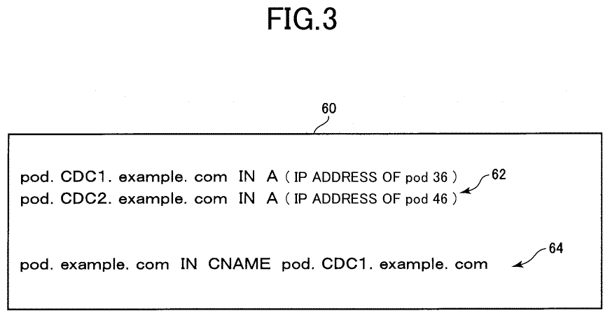

In this embodiment, service data is registered in the GC cluster 12. The service data indicates a role in a given process (for example, the above-mentioned application process) of at least one external system (for example, the CDC cluster 14a or the CDC cluster 14b). As an example of this service data, there is known a DNS record which is illustrated in FIG. 3, and is stored in the coreDNS 21 of the GC cluster 12.

FIG. 3 shows an example of the DNS record stored in the coreDNS 21 of the GC cluster 12. This figure shows the DNS record initially set to the coreDNS 21. A DNS record 60 includes an A record 62 which associates an FQDN (pod.CDC1.example.com) of the pod 36 of the CDC cluster 14a and the IP address of the pod 36 with each other. Moreover, the DNS record 60 includes an A record 62 which associates an FQDN (pod.CDC2.example.com) of the pod 46 of the CDC cluster 14b and the IP address of the pod 46 with each other.

Further, the DNS record 60 includes a CNAME record 64, which associates the transmission destination virtual domain name (pod.example.com) corresponding to the group of the pod 36 and the pod 46 and, as an alternative name, the FQDN (pod.CDC1.example.com) of the pod 36 with each other.

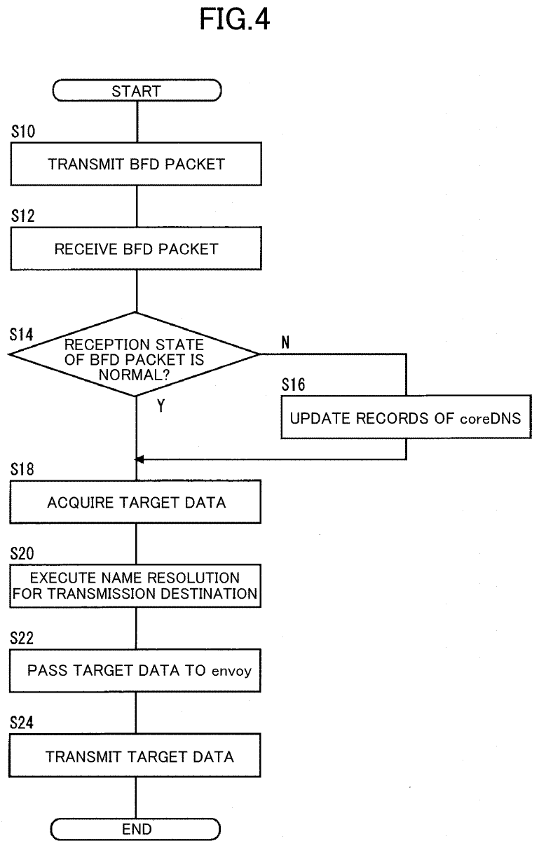

FIG. 4 is a flowchart for illustrating an operation of the GC cluster 12. First, description is given of an operation at the time when the state of the CDC cluster 14a is normal, and the communication path between the GC cluster 12 and the CDC cluster 14a is also normal. The bfd unit 22 of the GC cluster 12 repeatedly executes a process of transmitting the BFD packet to the bfd unit 31 of the CDC cluster 14a every predetermined period. Moreover, the bfd unit 22 repeatedly executes a process of transmitting the BFD packet to the bfd unit 41 of the CDC cluster 14b every predetermined time period (Step S10).

Further, the bfd unit 22 of the GC cluster 12 sequentially receives the BFD packet repeatedly transmitted from the bfd unit 31 of the CDC cluster 14a every predetermined time period. Still further, the bfd unit 22 sequentially receives the BFD packet repeatedly transmitted from the bfd unit 41 of the CDC cluster 14b every predetermined time period (Step S12). It is assumed that any one of the BFD packet from the CDC cluster 14a and the BFD packet from the CDC cluster 14b is repeatedly received, for example, every several seconds. The update unit 23 of the GC cluster 12 determines that the reception state of the BFD packet in the bfd unit 22 is normal, and thus skips the process of updating the DNS record 60 of the coreDNS 21 (Y in Step S14).

The pod 26 of the GC cluster 12 acquires the target data to be transmitted to the CDC cluster 14a or the CDC cluster 14b (Step S18). The pod 26 transmits, to the coreDNS 21, an inquiry for the name resolution having the specified transmission destination virtual domain name (pod.example.com). The coreDNS 21 returns, to the pod 26, the IP address of the pod 36 corresponding to the transmission destination virtual domain name (Step S20). The pod 26 may sequentially search the CNAME records 64 and the A records 62 of the coreDNS 21 to acquire, from the coreDNS 21, the IP address of the pod 36 corresponding to the transmission destination virtual domain name.

The pod 26 of the GC cluster 12 passes, to the envoy 27, an electronic message which includes the target data, and has the specified IP address of the pod 36 as the transmission destination address (Step S22). The envoy 27 performs by proxy, as the proxy unit, the reception of the target data from the pod 26, and the transmission of the target data to the CDC cluster 14a or the CDC cluster 14b. In this case, the envoy 27 sends out an electronic message which includes the target data, and has the specified IP address of the pod 36 as the transmission destination address, to the WAN 52, to thereby transmit the target data to the pod 36 (envoy 37) of the CDC cluster 14a (Step S24).

Description is now given of an operation at the time when a failure occurs in the CDC cluster 14a or a failure occurs in the communication path between the GC cluster 12 and the CDC cluster 14a. The bfd unit 22 of the GC cluster 12 has not received the BFD packet transmitted from the bfd unit 31 of the CDC cluster 14a for a time period longer than the predetermined time period. Meanwhile, the bfd unit 22 continues to repeatedly receive the BFD packet transmitted from the bfd unit 41 of the CDC cluster 14b at the predetermined time intervals.

The update unit 23 of the GC cluster 12 checks the reception state of the BFD packet in the bfd unit 22. When the BFD packet from the CDC cluster 14a has not been received for a time period longer than the predetermined time period, and the BFD packet from the CDC cluster 14b continues to be received periodically (N in Step S14), the update unit 23 updates the records of the coreDNS 21 such that the transmission destination address of the target data is changed from the IP address of the pod 36 of the CDC cluster 14a to the IP address of the pod 46 of the CDC cluster 14b (Step S16).

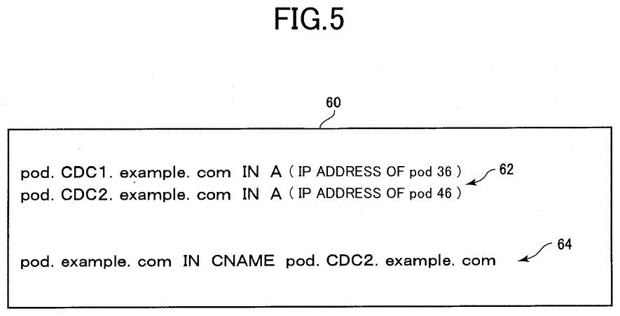

FIG. 5 shows an example of the DNS record stored in the coreDNS 21 of the GC cluster 12. This figure shows the DNS record after the update. The update unit 23 changes the CNAME record 64 so that the CNAME record 64 associates the transmission destination virtual domain name (pod.example.com) corresponding to the group of the pod 36 and the pod 46 and, as an alternative name, the FQDN (pod.CDC2.example.com) of the pod 46 with each other.

Referring back to FIG. 4, the pod 26 of the GC cluster 12 acquires the target data (Step S18), transmits, to the coreDNS 21, an inquiry for the name resolution that has the specified transmission destination virtual domain name (pod.example.com), and acquires, from the coreDNS 21, the IP address of the pod 46 associated with the transmission destination virtual domain name (Step S20). The pod 26 passes, to the envoy 27, an electronic message which includes the target data, and has the specified IP address of the pod 46 as the transmission destination address (Step S22). The envoy 27 sends out this electronic message to the WAN 52, to thereby transmit the target data to the pod 46 (envoy 47) of the CDC cluster 14b (Step S24). The process steps of Step S10 to Step S16 of FIG. 4 and the process steps of Step S18 to Step S24 thereof may be executed in parallel.

As described above, when a failure occurs in the CDC cluster 14a, which is the original transmission destination of the target data, or a failure occurs in the communication path between the GC cluster 12 and the CDC cluster 14a, the GC cluster 12 in the first embodiment can quickly detect the failure based on the reception state of the BFD packet. When the GC cluster 12 detects the occurrence of the failure, the GC cluster 12 transmits the target data to the CDC cluster 14b in place of the CDC cluster 14a, thereby being capable of suppressing a delay in the communication between the Kubernetes clusters.

Moreover, as described above, the CDC1 has the role as the transmission destination corresponding to the transmission destination virtual domain name (pod.example.com). Further, the CDC2 has the role as the backup (backup for the CDC1) of the transmission destination corresponding to the transmission destination virtual domain name (pod.example.com). Further, this state is indicated in the DNS record 60 of FIG. 3.

### Second Embodiment

In this embodiment, points different from the first embodiment are mainly described, and description of common points is appropriately omitted. Of the components in this embodiment, components which are the same as or correspond to the components in the first embodiment are denoted by the same reference symbols for the description.

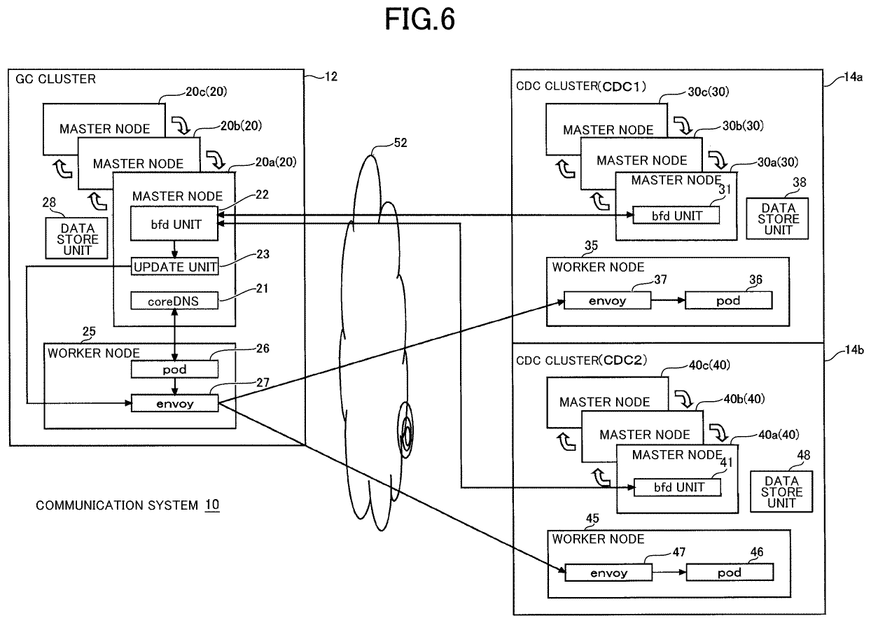

FIG. 6 is a diagram for illustrating a configuration of a communication system 10 in the second embodiment. The communication system 10 in the second embodiment includes the GC cluster 12, the CDC cluster 14a, and the CDC cluster 14b as in the communication system 10 in the first embodiment. The node configuration and functional blocks of each cluster in the second embodiment are equivalent to those in the first embodiment.

The envoy 27 of the GC cluster 12 performs by proxy, as the proxy unit, the reception of the target data from the pod 26, and the transmission of the target data to the CDC cluster 14a. When the envoy 27 has not received the BFD packet from the CDC cluster 14a, the envoy 27 rewrites the transmission destination address of the target data from the IP address of the CDC cluster 14a to the IP address of the CDC cluster 14b.

An operation of the communication system 10 in the second embodiment is now described. The description is given of, as an operation different from that of the communication system 10 in the first embodiment, an operation at the time when a failure occurs in the CDC cluster 14a or a failure occurs in the communication path between the GC cluster 12 and the CDC cluster 14a.

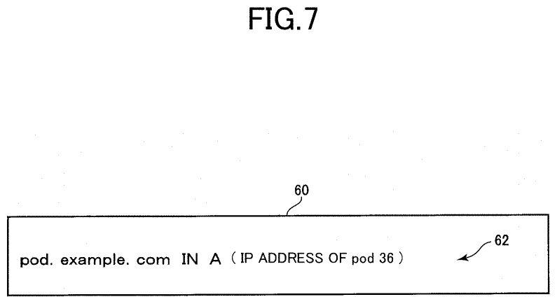

FIG. 7 shows an example of the DNS record stored in the coreDNS 21 of the GC cluster 12. The DNS record 60 includes A records 62 which associate the transmission destination virtual domain name (pod.example.com) corresponding to the group of the pod 36 of the CDC cluster 14a and the pod 46 of the CDC cluster 14b and the IP address of the pod 36 of the CDC cluster 14a with each other. The DNS record 60 in the second embodiment is not changed even when the reception state of the BFD packet has changed, which is different from the DNS record 60 in the first embodiment.

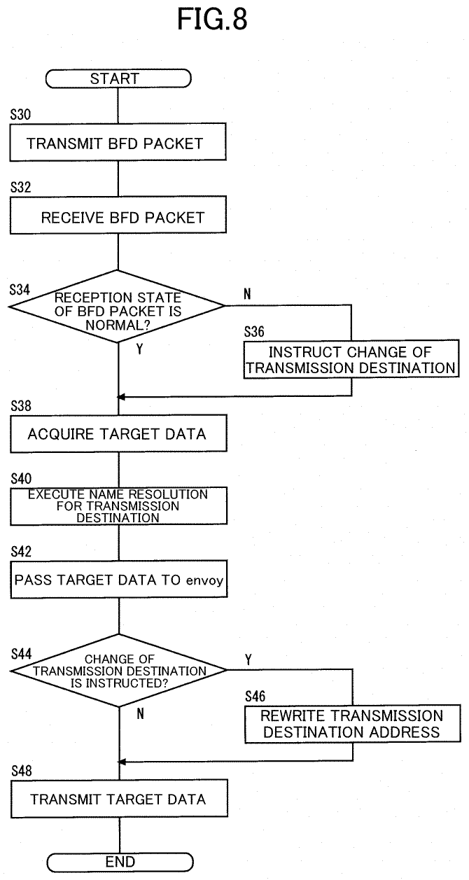

FIG. 8 is a flowchart for illustrating an operation of the GC cluster 12. Step S30 and Step S32 of the figure are the same as Step S10 and Step S12 of FIG. 4, and thus description thereof is omitted. The update unit 23 of the GC cluster 12 checks the reception state of the BFD packet in the bfd unit 22. In this case, the BFD packet from the CDC cluster 14a has not been received for a time period longer than the predetermined time period while the BFD packet from the CDC cluster 14b continues to be received periodically.

The update unit 23 determines that the reception state of the BFD packet is abnormal (N in Step S34), and instructs the envoy 27 to change the transmission destination address of the target data from the IP address of the pod 36 of the CDC cluster 14a to the IP address of the pod 46 of the CDC cluster 14b (Step S36). For example, the update unit 23 may store files and flags having contents that instruct a change of the transmission destination address of the target data from the IP address of the pod 36 to the IP address of the pod 46 in a storage area that can be referred to by the envoy 27. When the reception state of the BFD packet is normal (Y in Step S34), the update unit 23 skips the process step of Step S36.

The pod 26 of the GC cluster 12 acquires the target data (Step S38), transmits, to the coreDNS 21, an inquiry for the name resolution that has the specified transmission destination virtual domain name (pod.example.com), and acquires, from the coreDNS 21, the IP address of the pod 36 of the CDC cluster 14a associated with the transmission destination virtual domain name (Step S40). The pod 26 passes, to the envoy 27, an electronic message (hereinafter referred to as “transmission electronic message”) which includes the target data, and has the specified IP address of the pod 36 as the transmission destination address (Step S42).

When the envoy 27 receives, from the update unit 23, the instruction to change the transmission destination address, and, for example, a file including this instruction is stored in a predetermined storage area (Y in Step S44), the envoy 27 rewrites the transmission destination address of the transmission electronic message output from the pod 26 to the IP address of the pod 46 of the CDC cluster 14b (Step S46). The envoy 27 sends out, to the WAN 52, the transmission electronic message after the transmission destination address has been rewritten, to thereby transmit the target data to the pod 46 (envoy 47) of the CDC cluster 14b (Step S48).

When the envoy 27 has not received the instruction to change the transmission destination address (N in Step S44), the envoy 27 skips the process step of Step S46. In this case, the envoy 27 sends out, to the WAN 52, the transmission electronic message output from the pod 26 without rewriting the transmission destination address, to thereby transmit the target data to the pod 36 (envoy 37) of the CDC cluster 14a (Step S48). The process steps of Step S30 to Step S36 of FIG. 8 and the process steps of Step S38 to Step S48 thereof may be executed in parallel.

The GC cluster 12 in the second embodiment also provides an effect equivalent to that of the GC cluster 12 in the first embodiment. That is, also in the communication system 10 in the second embodiment, the delay of the communication between the Kubernetes clusters can be suppressed.

### Third Embodiment

In a third embodiment of the present disclosure, as described below, the communication between the clusters is established with registration of a resource in the data store unit 28 as a trigger.

In the third embodiment, description is mainly given of functions relating to the establishment of the communication between the clusters triggered by the registration of a resource in the data store unit 28 and points different from the first embodiment and the second embodiment, and description of common points is appropriately omitted. Of the components in this embodiment, components which are the same as or correspond to the components in the first embodiment and the second embodiment are denoted by the same reference symbols for the description.

In the third embodiment, the GC cluster 12 registers, in the data store unit 28, resource data indicating an address of an external system that can respond to any computer system in response to reception of a communication establishment request from this computer system.

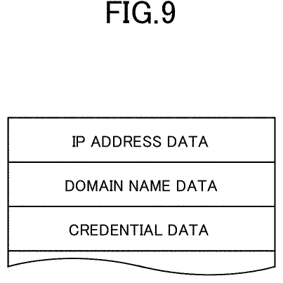

FIG. 9 is a diagram for illustrating an example of data structure of the resource data registered in the data store unit 28 of the GC cluster 12. As illustrated in FIG. 9, the resource data includes, for example, address data, domain name data, and credential data.

The resource data in the third embodiment is data associated with the computer systems, for example, the clusters included in the communication system 10.

The address data included in the resource data is data indicating addresses (in this case, for example, the IP addresses) of the computer systems associated with the resource data.

The domain name data included in the resource data is data indicating domain names (in this case, for example, the FQDNs) of the computer systems associated with the resource data.

The credential data included in the resource data is data indicating authentication information (credentials), such as user names and passwords, which is required to establish the communication to and from the computer systems associated with the resource data.

In the following description, it is assumed that, in an initial state, the resource data on the CDC1 and the CDC2 is not registered in the data store unit 28 of the GC cluster 12.

Moreover, in the following description, it is assumed that the master node 20a is selected in advance as the leader of the GC cluster 12. Further, it is assumed that the bfd unit 22 of the GC cluster 12 is activated, and is brought into a state in which the bfd unit 22 can execute the communication.

In this embodiment, it is assumed that, for example, the setup of the CDC1 is finished, and the CDC1 can thus be used. Moreover, it is assumed that the master node 30a is selected as the leader of the CDC cluster 14a. Further, it is assumed that the bfd unit 31 of the CDC cluster 14a is activated after that, and is brought into a state in which the bfd unit 31 can respond to any computer system in response to reception of a communication establishment request from this computer system.

In this situation, the GC cluster 12 registers, in the data store unit 28, the resource data indicating the address of the external system as described above, for example, in response to an operation of the developer. In this situation, for example, the GC cluster 12 corresponds to a given computer system, and the CDC1 corresponds to the external system.

After that, the bfd unit 22 of the GC cluster 12 establishes communication between the given computer system and the external system in response to the registration of the resource data by performing control so that the given computer system transmits the communication establishment request to the external system having the address indicated in the resource data. In this situation, the CDC1 corresponds to the external system, and the given computer system corresponds to the GC cluster 12. In this example, the computer system with which the communication to and from the CDC1 is established is the GC cluster 12, which is the same as the computer system in which the resource data is registered. The computer system with which the communication to and from the CDC1 is established and the computer system in which the resource data is registered may be different from each other.

For example, the bfd unit 22 of the GC cluster 12 executes the negotiation with the bfd unit 31 of the CDC cluster 14a with the registration of the resource data associated with the CDC1 in the data store unit 28 as a trigger. The communication (BFD session) between the GC cluster 12 and the CDC cluster 14a is established by this negotiation, and the transmission destination and the transmission timing of the BFD packet are set.

After that, the GC cluster 12 sets a role, in a given process to be executed by the given computer system, of the external system with which the communication has been established. For example, the application process executed by the GC cluster 12 corresponds to the given process executed by the given computer system.

In this case, the GC cluster 12 may register service data indicating the role of the external system (in this case, for example, CDC1) in the given process, for example, in response to an operation of the developer. As an example of the service data, the DNS record 60 to be used for the name resolution for the transmission destination of the above-mentioned target data is known.

For example, it is assumed that the DNS record 60 exemplified in FIG. 7 is registered in the coreDNS 21 of the GC cluster 12 in response to an operation of the developer. As described above, the DNS record 60 of FIG. 7 includes the A record 62 which associates the transmission destination virtual domain name (pod.example.com) corresponding to the group of the pod 36 of the CDC cluster 14a and the pod 46 of the CDC cluster 14b and the IP address of the pod 36 of the CDC cluster 14a with each other.

In this configuration, as described above, the coreDNS 21 returns the IP address of the pod 36 to the pod 26 in response to the inquiry for the name resolution, which is transmitted from the pod 26, and has the specified transmission destination virtual domain name (pod.example.com).

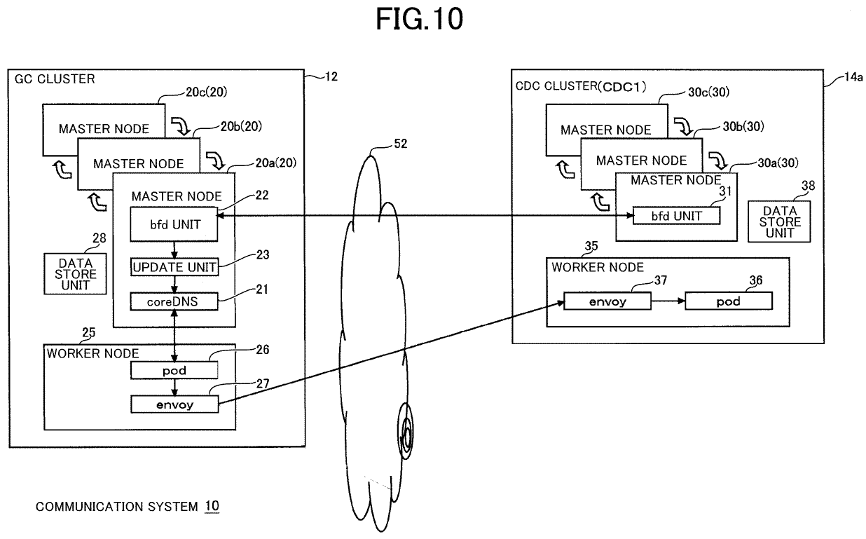

In this manner, as illustrated in FIG. 10, the target data acquired by the pod 26 of the GC cluster 12 can be transmitted to the CDC cluster 14a via the envoy 27.

After that, for example, it is assumed that the CDC cluster 14b which plays a role as the backup of the CDC cluster 14a is set up, and the CDC2 thus becomes available. Moreover, it is assumed that the master node 30b is selected as the leader of the CDC cluster 14b. It is assumed that the bfd unit 41 of the CDC cluster 14b is activated after that, and is brought into a state in which the bfd unit 41 can respond to any computer system in response to reception of a communication establishment request from this computer system.

After that, the GC cluster 12 registers resource data indicating an address of a new external system in the data store unit 28 while the given computer system is executing the given process in cooperation with the existing external system. In this situation, for example, the GC cluster 12 corresponds to the given computer system, the CDC1 corresponds to the existing external system, and the CDC2 corresponds to the new external system.

In this case, resource data associated with the CDC2 is registered in the data store unit 28, for example, in response to an operation of the developer.

After that, the bfd unit 22 of the GC cluster 12 establishes the communication between the GC cluster 12 and the CDC2 in response to the registration of the resource data by performing control so that the given computer system transmits the communication establishment request to the external system having the address indicated in the resource data.

For example, the bfd unit 22 of the GC cluster 12 executes the negotiation with the bfd unit 41 of the CDC cluster 14b with the registration of the resource data associated with the CDC2 in the data store unit 28 as a trigger. The communication (BFD session) between the GC cluster 12 and the CDC cluster 14b is established by the negotiation, and the transmission destination and the transmission timing of the BFD packet are set.

After that, the GC cluster 12 sets a role, in terms of a relationship with the existing external system in the given process, of the external system with which the communication has been established. In this situation, for example, the CDC2 corresponds to the external system with which the communication has been established, and the CDC1 corresponds to the existing external system.

In this case, for example, the role of the CDC2 may be set as the backup of the CDC1.

For example, in response to an operation of the developer, the DNS record 60 registered in the coreDNS 21 of the GC cluster 12 may be updated from the state of FIG. 7 to the state of FIG. 3.

As described above, the DNS record 60 of FIG. 3 includes the A record 62 which associates the FQDN (pod.CDC1.example.com) of the pod 36 of the CDC cluster 14a and the IP address of the pod 36 with each other. Moreover, the DNS record 60 includes the A record 62 which associates the FQDN (pod.CDC2.example.com) of the pod 46 of the CDC cluster 14b and the IP address of the pod 46 with each other.

Further, the DNS record 60 includes the CNAME record 64 which associates the transmission destination virtual domain name (pod.example.com) corresponding to the group of the pod 36 and the pod 46 and, as the alternative name, the FQDN (pod.CDC1.example.com) of the pod 36 with each other.

As described above, the DNS record 60 of FIG. 3 indicating that the CDC2 is the backup of the CDC1 is registered in the coreDNS 21.

In the third embodiment, as in the first embodiment, the pod 26 transmits the target data relating to the given process to the existing external system.

Moreover, as in the first embodiment, it is assumed that a failure occurs in the existing external system or a failure occurs in the communication path between the given computer system and the existing external system.

In this case, the pod 26 transmits the target data to the new external system in place of the existing external system.

In this situation, for example, the CDC1 corresponds to the existing external system, the GC cluster 12 corresponds to the given computer system, and the CDC2 corresponds to the new external system (see FIG. 2).

Thus, also in the third embodiment, the delay of the communication between the Kubernetes clusters can be suppressed.

Also in the third embodiment, as in the first embodiment, the bfd unit 22 may receive a packet (for example, the BFD packet) which is repeatedly transmitted from the CDC1, and is used to monitor the normality of the path to the CDC1.

Moreover, the bfd unit 22 may receive a packet (for example, the BFD packet) which is repeatedly transmitted from the CDC2, and is used to monitor the normality of the path to the CDC2.

Further, as in the first embodiment, the pod 26 may transmit the target data to the CDC2 in place of the CDC1 when the packet from the CDC1 has not been received. In this case, when the pod 26 has not received the packet from the CDC1, and has received the packet from the CDC2, the pod 26 may transmit the target data to the CDC2 in place of the CDC1.

In the third embodiment, when the resource data on the CDC1 is to be registered, the bfd unit 31 of the CDC1 has already been activated. Moreover, when the resource data on the CDC2 is to be registered, the bfd unit 41 of the CDC2 has already been activated. Thus, in the third embodiment, when the resource data is registered, the BFD session corresponding to the registered resource data is to be established without the operation of the developer.

Moreover, in the third embodiment, the additional installation of the external system and the registration of the external system in the service can be executed independently of each other. Thus, after several external systems are additionally installed in advance, and the establishment of the BFD sessions is executed, the external systems with which the BFD session has been established can be registered as required in the service (for example, the external systems can be registered in the DNS record 60).

As described above, according to the third embodiment, the communication system 10 can smoothly be extended.

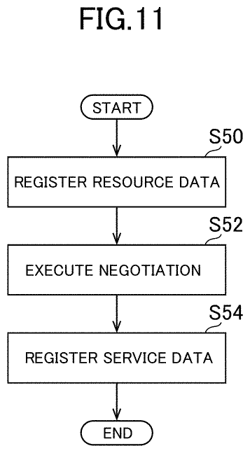

With reference to FIG. 11, an example of a flow of a process executed by the GC cluster 12 in the third embodiment is now described.

First, the GC cluster 12 registers, in the data store unit 28, resource data on an external system to be newly added to the communication system 10 in response to the operation of the developer (Step S50).

After that, the bfd unit 22 of the GC cluster 12 refers to the resource data registered by the process step of Step S50 to execute the negotiation with the external system associated with this resource data through use of the bfd (Step S52). Processes relating to this negotiation include, for example, a transmission process for the communication establishment request from the GC cluster 12 to the external system. In the process step of Step S52, the external system which is the opposite party of the negotiation may be identified based on the resource data. The credential data included in the resource data may be used to execute authentication for the identified external system. Moreover, in the process step of Step S52, the resource data registered by the process step of Step S50 may be transmitted to the external system. After that, the resource data may be registered in the data store unit of the external system. Through the execution of the process step of Step S52, the communication between the GC cluster 12 and the external system is established.

After that, in response to an operation of the developer, the GC cluster 12 registers, in the coreDNS 21, the service data (DNS record 60 in the above-mentioned example) indicating the role of the external system associated with the resource data registered by the process step of Step S50 (Step S54). After that, the process of this process example is finished.

After that, the process similar to the process of FIG. 4 is executed.

It is not required to execute the registration of the DNS record 60 by the process step of Step S54. For example, in response to the registration of the resource data by the process step of Step S50, the GC cluster 12 may perform control so that the operation of FIG. 8 is executed from the state in which the target data is transmitted only to the CDC cluster 14a. For example, the GC cluster 12 may perform control so that the target data is transmitted to the CDC cluster 14b when the BFD packet has not been received from the CDC cluster 14a.

In the above, the present disclosure has been described based on the first embodiment, the second embodiment, and the third embodiment. Those embodiments are given as examples. A person skilled in the art would understand that various modification examples are possible in the combinations of the components and processing processes, and that those modifications examples are also within the scope of the technology of the present disclosure.

Any combination of the above-mentioned embodiments and modifications examples is also valid as an embodiment of the present disclosure. New embodiments resulting from such combinations have the advantageous effects of the embodiments and modifications examples included in the combination. A person skilled in the art would also understand that each of the functions to be achieved by the constituent features recited in the claims is implemented alone by each of the components described in the embodiments and the modification examples or by the components working together.

1. A management system, comprising:
at least one processor; and
at least one memory device storing instructions which when executed by the at least one processor, cause the at least one processor to perform operations comprising:
registering resource data indicating an address of an external system capable of responding to any computer system in response to reception of a communication establishment request from the any computer system;
establishing communication between a given computer system and the external system in response to registration of the resource data by performing control so that the given computer system transmits the communication establishment request to the external system having the address indicated in the resource data; and
setting a role, in a given process to be executed by the given computer system, of the external system with which the communication has been established.

2. The management system according to claim 1,
wherein the registering comprises registering the resource data indicating an address of a new external system when the given computer system is executing the given process in cooperation with an existing external system,
wherein the establishing comprises establishing communication between the given computer system and the new external system in response to the registration of the resource data, and
wherein the setting comprises setting a role, in the given process, of the new external system with which the communication has been established, in terms of a relationship with the existing external system.

3. The management system according to claim 2, wherein the setting comprises setting the role of the new external system as a backup of the existing external system.

4. The management system according to claim 3, wherein the operations further comprise transmitting, to the existing external system, target data relating to the given process, wherein the transmitting comprises transmitting the target data to the new external system in place of the existing external system when a failure of the existing external system occurs or a failure of a communication path between the given computer system and the existing external system occurs.

5. The management system according to claim 4, wherein the operations further comprise receiving a packet which is repeatedly transmitted from the existing external system, and is used to monitor normality of a path to the existing external system,
wherein the transmitting comprises transmitting the target data to the new external system in place of the existing external system when the packet has not been received from the existing external system.

6. The management system according to claim 5,
wherein the receiving comprises receiving a packet which is repeatedly transmitted from the new external system, and is used to monitor normality of a path to the new external system, and
wherein the transmitting comprises transmitting the target data to the new external system in place of the existing external system when the packet has not been received from the existing external system, and the packet has been received from the new external system.

7. The management system according to claim 5, wherein the packet is a bidirectional forwarding detection (BFD) packet.

8. The management system according to claim 1, wherein the operations further comprise registering service data indicating the role of the external system in the given process.

9. The management system according to claim 8, wherein the service data is a domain name system (DNS) record to be used for name resolution for a transmission destination of target data relating to the given process.

10. A management method, comprising the steps of:
registering resource data indicating an address of an external system capable of responding to any computer system in response to reception of a communication establishment request from the any computer system;
establishing communication between a given computer system and the external system in response to registration of the resource data by performing control so that the given computer system transmits the communication establishment request to the external system having the address indicated in the resource data; and
setting a role, in a given process to be executed by the given computer system, of the external system with which the communication has been established.
